(19) United States
(12) Patent Application Publication
(10) Pub. No.: US 2006/0194174 A1
(43) Pub. Date: Aug. 31, 2006

(54) River rock creations

(76) Inventors: Jimmie R. Derington, California Hot Springs, CA (US); Blake R. Derington, California Hot Springs, CA (US)

Correspondence Address: LITMAN LAW OFFICES, LTD, PO BOX 15035, CRYSTAL CITY STATION, ARLINGTON, VA, 22215, US

(21) Appl. No.: 11/065,050

(22) Filed: Feb. 25, 2005

(51) Int. Cl. G09B 11/00

(52) U.S. Cl. 434/81

(57) ABSTRACT

Stone statuary and the method of making the same. The materials used to create the statuary are well-rounded alluvial rocks, which rocks are naturally polished by running river water. Such rocks are commonly known as “river rocks”. The natural colors and visual textures of the rocks will vary. The rocks may be employed in their natural matte tones. Alternatively, the intensity of the colors and textures may be enhanced by the application of a shiny polyurethane finish. Steel pins and epoxy glue are employed to connect the various components of the statuary.

### BACKGROUND OF THE INVENTION

1. Field of the Invention

The present invention generally relates to stone ornamentation. More specifically, the invention is drawn to structural arrangements for river rocks and a method to accomplish such structural arrangements.

2. Description of the Related Art

Homeowners (and renters too) are constantly seeking ways to add a bit of “feng shui” to their immediate environment. To this end, an entire industry is geared to create unique statuary art decoration for indoor and outdoor display. There is an abundance of stone sculpture available for decorating purposes. A sampling of this sculpture is disclosed in the related art documents as identified and cited in the accompanying IDS. However, none of the cited inventions and patents, taken either singly or in combination, is seen to disclose the river rock arrangement as will be subsequently described and claimed in the instant invention.

### SUMMARY OF THE INVENTION

The present invention is drawn to stone statuary and the method of making the same. The materials used to create the statuary are well-rounded alluvial rocks, which rocks are naturally polished by running river water. Such rocks are commonly known as “river rocks”. The natural colors and visual textures of the rocks will vary. The rocks may be employed in their natural matte tones. Alternatively, the intensity of the colors and textures may be enhanced by the application of a shiny polyurethane finish.

Careful selection and joining of the rocks will allow the creator to create statuary that may take on any form imaginable. The size of the completed statuary piece will depend on the item (person, animal, etc.) being created. A method of joining the rocks employs the use of threaded steel pins and epoxy glue. This joining arrangement creates a lasting bond that cannot be achieved with other procedures. The statuary can be placed indoors or outdoors, in sunny or inclement locations, in running streams, ponds and swimming pools. The lifespan of the statuary is very long because of the materials used and the method of construction.

Accordingly, the instant invention presents unique stone ornamentation for both inside and outside use. The invention provides for improved elements and arrangements thereof in an arrangement and method for the purposes described which are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a river rock creation according to the present invention.

FIG. 2 is an environmental, perspective view of a second river rock creation according to the present invention.

FIG. 3 is an environmental, perspective view of a third river rock creation according to the present invention.

FIG. 4 is an exploded view of FIG. 3 according to the present invention.

Similar reference characters denote corresponding features consistently throughout the attached drawings.

### DETAILED DESCRIPTION OF THE PREFERRED EMBODIMENTS

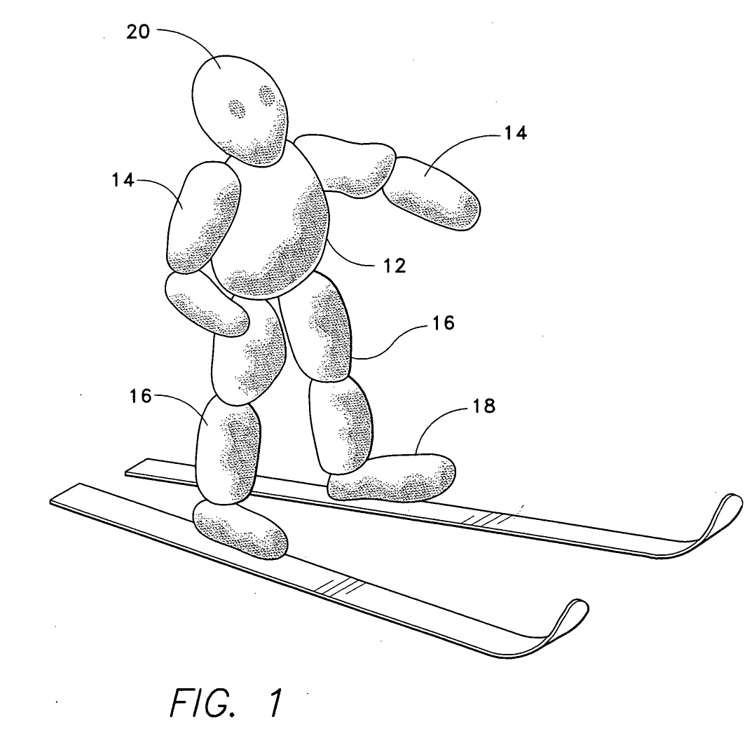

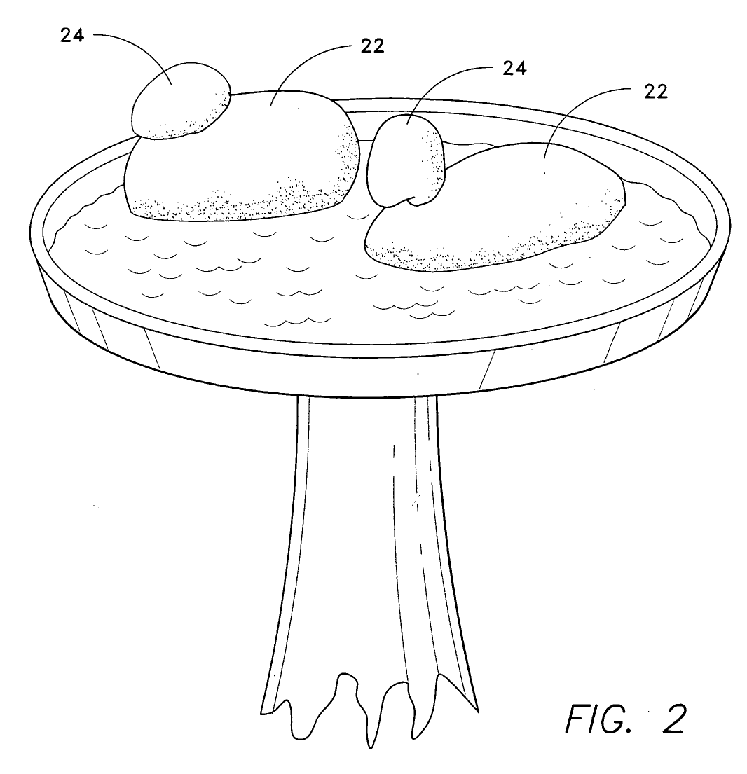

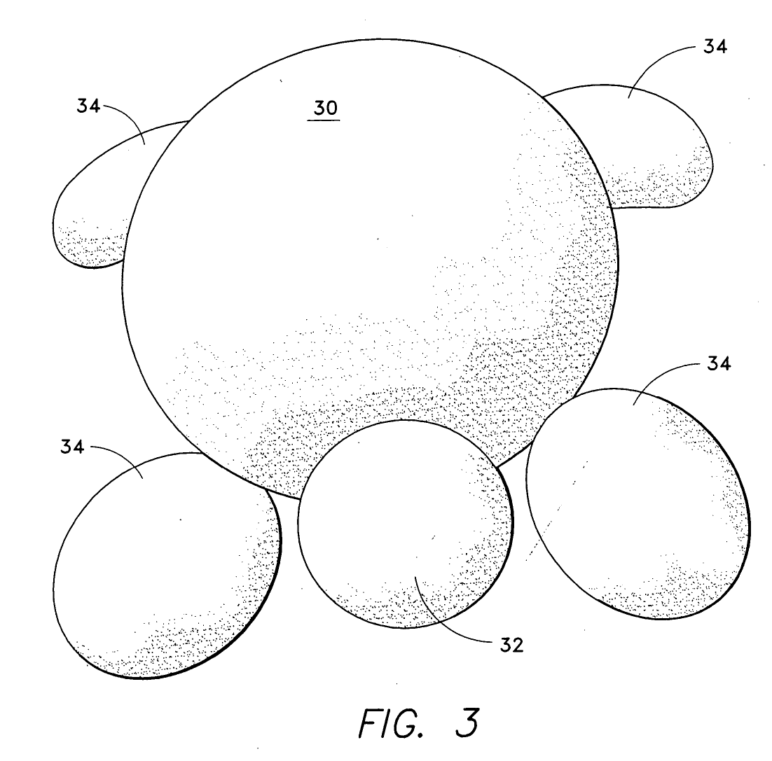

Attention is first directed to FIGS. 1-3, which Figs. Represent examples of statuary created with river rock. FIG. 1 depicts a skier. A suitably sized and contoured river rock 12 is selected to represent the skier's torso. Likewise other river rocks are chosen for representation of the arms 14, legs 16, feet 18 and head 20. FIG. 2 is illustrative of fowl, each having a body 22 and head 24 selected from appropriate river rocks. FIG. 3 shows a replica of a turtle having a body 30, head 32 and appendages 34. These three sculptures are only a sample of the infinite number of sculptures that may be created.

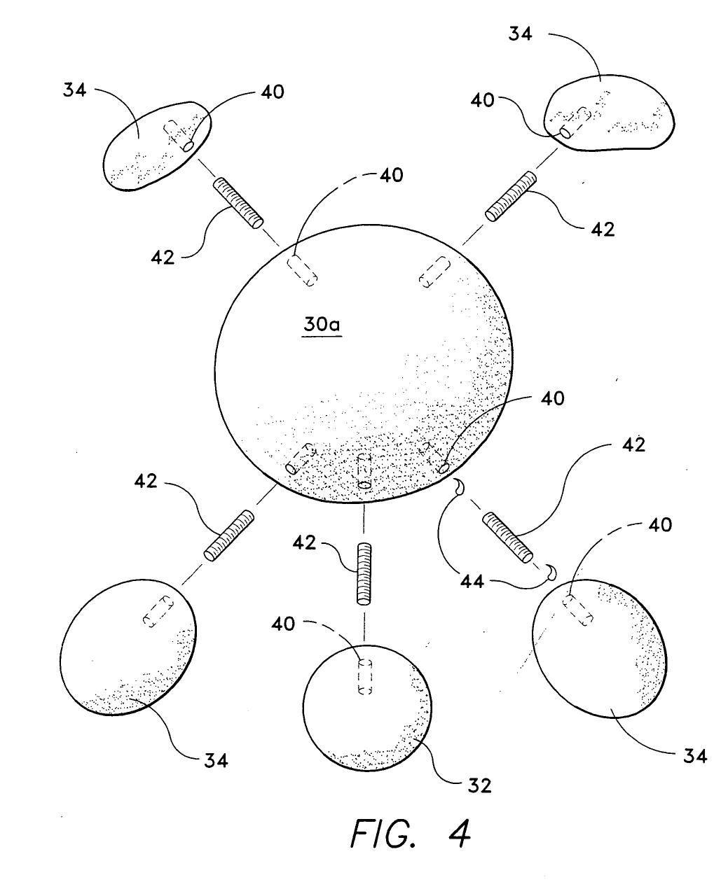

Attention is now directed to FIG. 4, which FIG. 4 illustrates the technique for assembling the statuary using the turtle of FIG. 3 as an example. Passages 40 are drilled in body 30, head 32 and appendages 34 at appropriate locations. Threaded steel pins 42 are inserted in the passages 40 to connect or join the head and the appendages to the body. Epoxy glue 44 is applied to reinforce the connection. As mentioned above, a shiny polyurethane may be applied to the surfaces of the statuary to intensify the natural color of the river rock.

It is to be understood that the present invention is not limited to the embodiments described above, but encompasses any and all embodiments within the scope of the following claims.

We claim:

1. A statuary creation, comprising:
a first rock selected to resemble a statuary body member;
a second rock selected to resemble a statuary head member;
a plurality of additional rocks selected to resemble statuary appendages;
plural passages drilled in said first rock;
at least one passage drilled in said second rock;
at least one passage drilled in each of said additional rocks; and
joining structures inserted in said plural passages and in each of said at least one passage for attaching said second rock and said plurality of additional rocks to said first rock.

2. The statuary creation according to claim 1, wherein said first rock, said second rock and said additional rocks are river rocks.

3. The statuary creation according to claim 1, wherein said joining structures are steel pins.

4. The statuary creation according to claim 1, wherein said joining structures include epoxy glue.

5. A statuary creation, comprising:
a first rock selected to resemble a statuary body member;
a second rock selected to resemble a statuary head member;
a plurality of additional rocks selected to resemble statuary appendages;
plural passages drilled in said first rock;
at least one passage drilled in said second rock;
at least one passage drilled in each of said additional rocks; and
threaded steel pins inserted in said plural passages and in each of said at least one passage for attaching said second rock and said plurality of additional rocks to said first rock.

6. The statuary creation according to claim 1, wherein epoxy glue is disposed on said threaded pins.

7. A method of making a statuary creation comprising the steps of:
selecting a river rock to resemble a body of the statuary creation;
selecting a river rock to resemble a head of the statuary creation;
selecting a plurality of river rocks to resemble appendages of the statuary creation;
drilling passages in said body, said head and said appendages;
employing steel pins inserted in said passages for attaching said head and said appendages to said body.

8. The method of making a statuary creation as recited in claim 7, further including the step of providing threads on said steel pins.

9. The method of making a statuary creation as recited in claim 8, further including the step of employing epoxy glue for attaching said head and said appendages to said body.

10. The method of making a statuary creation as recited in claim 9, further including the step of applying a shiny polyurethane to the selected river rocks.
